(19) United States
(12) Patent Application Publication
(10) Pub. No.: US 2026/0093827 A1
(43) Pub. Date: Apr. 2, 2026

(54) DATA TRANSFER SYSTEM AND METHOD

(71) Applicant: Apple Inc., Cupertino, CA (US)

(72) Inventors: Xu Si, Beijing (CN); Gianpaolo Fasoli, Redwood City, CA (US); Julia C. Hanson, San Francisco, CA (US); Rong Liao, Shanghai (CN); Jessica L. Roeder, Austin, TX (US); Bruno Kindarji, Versailles (FR); Alexander Wozniakowski, Cupertino, CA (US)

(73) Assignee: Apple Inc., Cupertino, CA (US)

(21) Appl. No.: 18/900,508

(22) Filed: Sep. 27, 2024

(51) Int. Cl. G06F 21/60

(52) U.S. Cl. CPC G06F 21/604; G06F 21/602

(57) ABSTRACT

A method may include determining that a data transfer has been initiated within an application executed on the user device. The method may include accessing one or more device signals indicating device use characteristics of the user device. The method may include accessing one or more application signals associated with the application executed on the user device. The method may include generating a first confidence value and a second confidence value representing a likelihood that the data transfer is invalid based at least in part on the one or more application signals and the one or more device signals. The method may include transmitting encrypted data may include at least one of the first confidence value, and the second confidence value, or a data transfer identifier to a computing system.

### BACKGROUND

Inauthentic data transfers cost efficiency, time, and money to different parties involved in the data transfers. Detecting an inauthentic data transfer may be accomplished by monitoring various data points associated with the data transfer and/or a device used in the data transfer. However, these data points may be used to derive sensitive information about one or more parties to the data transfer. Therefore, systems and techniques that can be used to detect inauthentic data transfers while protecting sensitive data are needed.

### BRIEF SUMMARY

A method may include determining, by a detection service executed on a user device, that a data transfer has been initiated within an application executed on the user device. The method may include accessing, by the detection service executed on the user device, one or more device signals indicating device use characteristics of the user device. The method may include accessing, by the application executed on the user device, one or more application signals associated with the application executed on the user device. The method may include generating, by a first machine learning model of the detection service, a first confidence value representing a likelihood that the data transfer is invalid based at least in part on the one or more application signals and a first portion of the one or more device signals. The method may include generating, by a second machine learning model of the detection service, a second confidence value representing the likelihood that the data transfer is invalid based at least in part on a second portion of the one or more device signals. The method may include transmitting, by the detection service, encrypted data may include at least one of the first confidence value, and the second confidence value, or a data transfer identifier to a computing system.

In some embodiments, the first portion of the one or more device signals and the second portion of the one or more device signals may include different device signals. The first portion of the device signals and the second portion of the device signals each may include an identical device signal. The first machine learning model may include at least one of a k-nearest neighbor model or a clustering model. An analysis module may determine particular device signals and particular application signals to be used by the detection service.

In some embodiments, the method may include. determining, by the computing system, that the data transfer is a fraudulent data transfer based at least in part on the first confidence value, the second confidence value, or any combination thereof. The method may include generating, by the computing system, a flag id associated with the data transfer, the flag id. The method may include and transmitting, by the computing system, the flag id to the user device and/or a third party. The one or more application signals may include at least one of an install duration, a daily use metric, or an average run time.

A system may include one or more processors. The system may include a computer-readable medium may include instructions that, when executed by the one or more processors, cause the system to determine, by a detection service executed on a user device, that a data transfer has been initiated within an application executed on the user device. The system may access, by the detection service executed on the user device, one or more device signals indicating device use characteristics of the user device. The system may access, by the application executed on the user device, one or more application signals associated with the application executed on the user device. The system may generate, by a first machine learning model of the detection service, a first confidence value representing a likelihood that the data transfer is invalid based at least in part on the one or more application signals and a first portion of the one or more device signals. The system may generate, by a second machine learning model of the detection service, a second confidence value representing the likelihood that the data transfer is invalid based at least in part on a second portion of the one or more device signals. The system may transmit, by the detection service, encrypted data may include at least one of the first confidence value, and the second confidence value, or a data transfer identifier to a computing system.

In some embodiments, the first portion of the one or more device signals and the second portion of one or more device signals may include different device signals. The first portion of the one or more device signals and the second portion of the one or more device signals each may include an identical device signal. First machine learning model may include at least one of a k-nearest neighbor model or a clustering model. An analysis module may determine particular device signals and particular application signals to be used by the detection service.

In some embodiments, the instructions may further cause the system to determine, by the computing system, that the data transfer is an inauthentic data transfer based at least in part on the first confidence value, the second confidence value, or any combination thereof. The system may generate, by the computing system, a flag ID associated with the data transfer, the flag ID. The system may transmit, by the computing system, the flag ID to the user device and/or a third party. The one or more application signals may include at least one of an install duration, a daily use metric, or an average run time.

A non-transitory computer-readable medium may include instructions that, when executed by one or more processors, cause the one or more processors to perform operations. The operations may include determining, by a detection service executed on a user device, that a data transfer has been initiated within an application executed on the user device. The operations may include accessing, by the detection service executed on the user device, one or more device signals indicating device use characteristics of the user device. The operations may include accessing, by the application executed on the user device, one or more application signals associated with the application executed on the user device. The operations may include generating, by a first machine learning model of the detection service, a first confidence value representing a likelihood that the data transfer is invalid based at least in part on the one or more application signals and a first portion of the one or more device signals. The operations may include generating, by a second machine learning model of the detection service, a second confidence value representing the likelihood that the data transfer is invalid based at least in part on a second portion of the one or more device signals. The operations may include transmitting, by the detection service, encrypted data may include at least one of the first confidence value, and the second confidence value, or a data transfer identifier to a computing system.

In some embodiments, the first portion of the one or more device signals and the one or more second portion of device signals may include different device signals. The first portion of the one or more device signals and the second portion of the one or more device signals each may include an identical device signal. The first machine learning model may include at least one of a k-nearest neighbor model or a clustering model. An analysis module may determine particular device signals and particular application signals to be used by the detection service. The operations may include determining, by the computing system, that the data transfer is an inauthentic data transfer based at least in part on the first confidence value, the second confidence value, or any combination thereof. The operations may include generating, by the computing system, a flag id associated with the data transfer, the flag id. The operations may include transmitting, by the computing system, the flag id to the user device and/or a third party.

### BRIEF DESCRIPTION OF THE DRAWINGS

FIG. 1 illustrates a system and a process for mitigating subtraction attacks during data transfer analysis, according to certain embodiments.

FIGS. 2A-2D illustrate a system for detecting inauthentic data transfers, according to certain embodiments.

FIG. 3 illustrates a flowchart of a method for identifying inauthentic data transfers, according to certain embodiments.

FIG. 4 illustrates an example architecture or environment configured to implement techniques relating to providing route management, according to certain embodiments.

### DETAILED DESCRIPTION

Data transfers occur between various devices regularly. These data transfers may be performed by any type of computing device, such as laptops, desktops, virtual machines, mobiles devices, etc. Some data transfers are between two entities, and a computing device (e.g., a personal computer), is used to initiate and/or perform the data transfer. As mobile devices have proliferated, however, different types of data transfers have become more common.

For example, a mobile device may initiate a data transfer that results in an application being installed on the mobile device. Additionally or alternative, a data transfer may be initiated with the application that then modifies the application or some aspect thereof (e.g., account information, etc.). The ease at which data transfers may be executed from mobile devices and/or apps executed by the mobile devices has also created risk for bad actors to execute inauthentic data transfers. These inauthentic data transfers may lead to devices being compromised, inefficient use of systems used in data transfers, and have financial consequences for parties involved in authentic data transfers (e.g., a user, third parties, etc.).

Detecting an inauthentic data transfer prior to the execution of the inauthentic data transfer may address at least some of these issues. One solution may be to gather one or more metrics about the mobile device, applications, etc. when a data transfer is initiated. Using the metrics, a computing system may make a prediction about the authenticity of a data transfer. For example, if a certain application is downloaded then soon thereafter used to perform several data transfers, the computing system may predict that the data transfer is inauthentic, flagging and/or denying the data transfer. This prediction, however, may be made using potentially sensitive information such as typical device behavior, application behavior, etc. Transmitting the metrics from the mobile device to a prediction model may therefore expose the sensitive information to unnecessary risk of being compromised. Alternatively, the metrics may be evaluated and assigned values on the mobile device. The values may then be transmitted to the prediction model. With some knowledge of the various metrics (e.g., what metrics are being measured), however, a bad actor may intercept the values and still derive the sensitive information via a subtraction attack. A subtraction attack is method of attacking aggregate data—in particular tables of counts—by removing known units (contributions) from the aggregate data to make inferences that can be made about units which are unknown or partially known. In other words, if even some of the various metrics are known, the known values may be used to make inferences about the other metrics, potentially exposing sensitive information. Thus, systems and techniques are needed to better predict inauthentic data transfers while safeguarding sensitive information.

One solution may be to execute a detection service on a mobile device. When a data transfer is initiated by an application on the mobile device, the detection service may determine one or more device signals and one or more application signals associated with the mobile device, the application, and/or the data transfer itself. Then, the detection service may divide the one or more device signals into two portions. The two portions may include at least some overlap (i.e., some of the same device signals are repeated in each of the two portions) or may be distinct from one another. The detection service may then generate values for each of the one or more application signals and the one or more device signals. To generate the values, the detection service may provide the application signals and the first portion of the device signals to a first machine learning model (MLM) and the second portion of the device signals to a second MLM. Then, the values may be transmitted to an associated computing system where a prediction may be made about the authenticity of the data transfer.

If a bad actor intercepts the values, a subtraction attack may noy yield any sensitive information. Because the two sets of values are based on different inputs (i.e., the application signals and the two portions of device signals), the values may not be used to derive sensitive information. As the respective inputs are put into respective MLMs, respective sets of values are generated. It may be difficult or impossible for the bad actor to determine which respective set of values correspond to each respective input. Additionally, because the respective inputs may or may not include overlap, a subtraction attack may not be possible because there may be no known values to subtract. Thus, the systems and techniques described herein may reduce the risk of exposing sensitive data, while still providing robust detection of inauthentic data transfers.

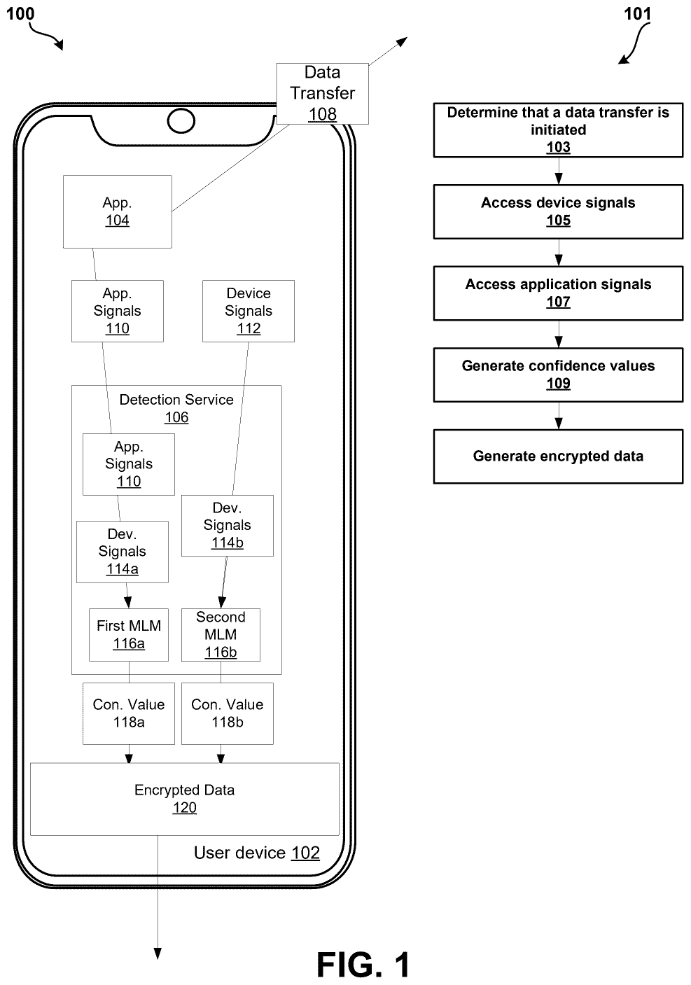

FIG. 1 illustrates a system 100 and a process 101 for preventing subtraction attacks during data transfer analysis, according to certain embodiments. The system 100 may include a user device 102. The mobile device may include an application 104 and a detection service 106. The detection service 106 may include a first MLM 116a and a second MLM 116b. The user device 102 may be a cell phone, smartphone, tablet, laptop, wearable (e.g., a watch, lapel pin, glasses, etc.), or any other type of computing device. The user device 102 may be associated with an entity that administers at least some functions performed by the user device 102. For example, the entity may be a developer, manufacturer etc. of the user device 102 and include one or more computing systems (not shown). The user device 102 and/or applications executed thereon (e.g., an operating system, daemon, etc.) may be part of a secure environment controlled by the entity and inaccessible to a user of the user device 102. Within the secure environment the user device 102 may transmit data to and from the computing systems of the entity such that the user of the user device 102 may not access the data (e.g., sensitive information). Thus, the user device 102 and the entity may communicate without sensitive data leaving the secure environment of the entity.

The detection service 106 may include one or more hardware and/or software components (e.g., application programming interfaces (APIs), memory components, etc.) of the user device 102. The detection service 106 may be configured to communicate with various components and services of the user device 102 to gather information associated with the user device 102. The detection service 106 may be part of the secure environment, and thus be inaccessible to the user of the user device 102. The detection service 106 may therefore also communicate with the computing systems of the entity.

The first and second MLMs 116a-b may be included in the detection service 106. The first and second MLMs 116a-b may each include a K-nearest neighbors model, a K-Means model, a hierarchical clustering model, logistic regression models, a Naive Bayes model, and/or any other suitable machine learning models. In some embodiments, the first and second MLMs 116a-b may include the same models. In other embodiments, the first and second MLMs 116a-b may include different models. The first and second MLMs 116a-b may be trained to output respective confidence values associated with the authenticity of data transfers based on respective inputs. The respective confidence values may be expressed as an integer (e.g., 1-10), a percentage (e.g., 10%, 90%, etc.), a float value (e.g., a decimal), or any other such value.

At 103, the detection service 106 may determine that the application 104 (or a user thereof) has initiated a data transfer 108. For example, the data transfer 108 may include a request to download and install another application (e.g., an app purchase). The application 104 may then request the other application from an external server administered by the entity and/or another party. The application 104 may then access account information associated with the user in order to download and install the other application (e.g., a wallet, card number etc.). In another example, the data transfer 108 may be an in-app purchase (IAP). The application 104 may request certain data from the external server in order to modify the application 104 in some way (e.g., add functionality, add data, etc.). In both cases, however, the account information of the user may be accessed and used. If the data transfer 108 is inauthentic (e.g., a fraudulent transaction), the user may be adversely affected by the data transfer 108 losing money, time, etc.

At 105, the detection service may determine the device signals 112. The device signals 112 may be determined from hardware and/or software components of the user device 102. The device signals 112 may include data associated with the user device 102 such as an input count (e.g., button usage), wallet data (e.g., stored payment methods, count of payment methods, usage data, etc.), email data (e.g., email application usage, email address(es), email address count, etc.), messaging data (e.g., SMS/MMS application usage, messaging frequency, etc.), contact data (e.g., most used contact(s), contact count, etc.), call data (e.g., count, frequency, etc.) and other such information. The device signals 112 may therefore potentially include sensitive information about the user and/or the user device 102. The device signals 112 may therefore be accessed and/or determined within the secure environment such that the user of the user device 102 may not access the device signals 112.

At 107, the detection service 106 may determine application signals 110. The application signals 110 may include information associated with the application 104 such as an install duration of the application 104 (i.e., how long the application has been installed on the mobile device), daily average application openings, application frequency (i.e., how often the application is opened within a given time period), average daily screen time, average session screen time, standard deviation of session screen time (i.e., how often the application 104 is open for during use), time data (e.g., when the application 104 was used, time windows, etc.), and other such information. The application signals 110 may also include information associated with other application executed on the user device 102, such as an install duration of the earliest application, daily average openings of all applications, daily average screen time of some or all applications, number of applications opened for a time period (1 day, 1 week, etc.), time-usage data (e.g., time windows where applications are opened), and/or other such information. While the application signals 110 may include more sensitive data than the device signals 112, the application signals 110 may also be accessed and determined within the secure environment, preventing the user from accessed the application signals.

At 109, the detection service 106 may generate first and second confidence values 118a-b. To do so, the detection service 106 may first divide the device signals 112 into a first portion 114a and a second portion 114b. Then, the first portion 114a and the application signals 110 may be provided to the first MLM 116a. The first MLM 116a may then generate the first confidence value 118a based at least in part on the first portion 114a and the application signals 110. For example, the application signals 110 may indicate that the install duration of the application 104 is 2 hours. The first MLM 114a may determine that 2 hours is relatively short and therefore likely to indicate that the data transfer 108 is an inauthentic (or fraudulent) data transfer. Accordingly, the first MLM 114a may generate a corresponding confidence value of 7 (e.g., out of 10). By contrast, if the install duration was longer (e.g., 10 months), the first MLM 114a may generate a corresponding confidence value indicating that the install duration does not make the data transfer 108 appear inauthentic (e.g., a corresponding confidence value of 1).

Similarly, the first MLM 116a may also generate confidence values for the device signals included in the first portion 114a. For example, the first portion 114a may include an input count associated with the data transfer 108 of 2. The first MLM 116a may determine that an input count of 2 is low for an average data transfer (e.g., indicating that an automated program may have initiated the data transfer 108) and therefore indicates a possible inauthentic data transfer. The first MLM 116a may then assign a corresponding confidence value of 8. By contrast, the input count may be 30. The first MLM 116a may then assign the corresponding confidence value indicating that the data transfer 108 is likely not an inauthentic data transfer (e.g., a corresponding confidence value of 2). As above, the first MLM 116a may assign corresponding confidence values to some or all of the application signals 110 and/or the first portion 114a. The corresponding confidence values may then collectively be output as the first confidence values 118a.

To generate the second confidence value 118b, the detection service 106 may input the second portion of the device signals 114b to the second MLM 116b. The second MLM 116b may be identical to the first MLM 116a or may be different. The second MLM 116b may then generate corresponding confidence values for each of the device signals in the second portion 114b. For example, the second portion 114b may include a contact count indicating that there are 0 contacts stored on the user device 102. The second MLM 116b may then determine that a contact count of 0 is associated with inauthentic data transfers and assign a respective confidence value accordingly (e.g., 9). By contrast, a contact count of 300 may indicate and authentic data transfer, and the second MLM 116b may assign the corresponding confidence value accordingly (e.g., 1). The second MLM 116b may assign corresponding confidence values to each of the device signals of the second portion 114b, which may then be collectively output as the second confidence value 118b.

The first and second portions 114a-b may include different device signals such that there is no overlap between the two. For example, the first portion 114a may include an input count, wallet data, and email data, etc. and the second portion 114b may include messaging data, contact data, call data, etc. The division of the device signals 112 may be predetermined—each device signal is organized into the first or second portions 114a-b according to instructions. In some embodiments, the division of the device signals in the first and second portions 114a-b may be random for each initiated data transfer. In yet another example, the first and second portions 114a-b may include some or all of the same device signals.

At 111, the detection service 106 (or an associated application executed on the user device 102) may consolidate the first and second confidence values 118a-b as encrypted data 120. The encrypted data 120 may be encrypted using a public key of a public-private key pair. The public-private key pair may be managed by the entity. Thus, the entity may be the only party with the private key. Although the first and second confidence values 118a-b are integers (or percentages, fractions, etc.), even if the encrypted data 120 were intercepted, a bad actor may not be able to access the corresponding confidence values. And even if the bad actor could access the first and second confidence values 118a-b, the division of the device signals 112 into the first and second portions 114a-b may make a subtraction attack difficult or impossible.

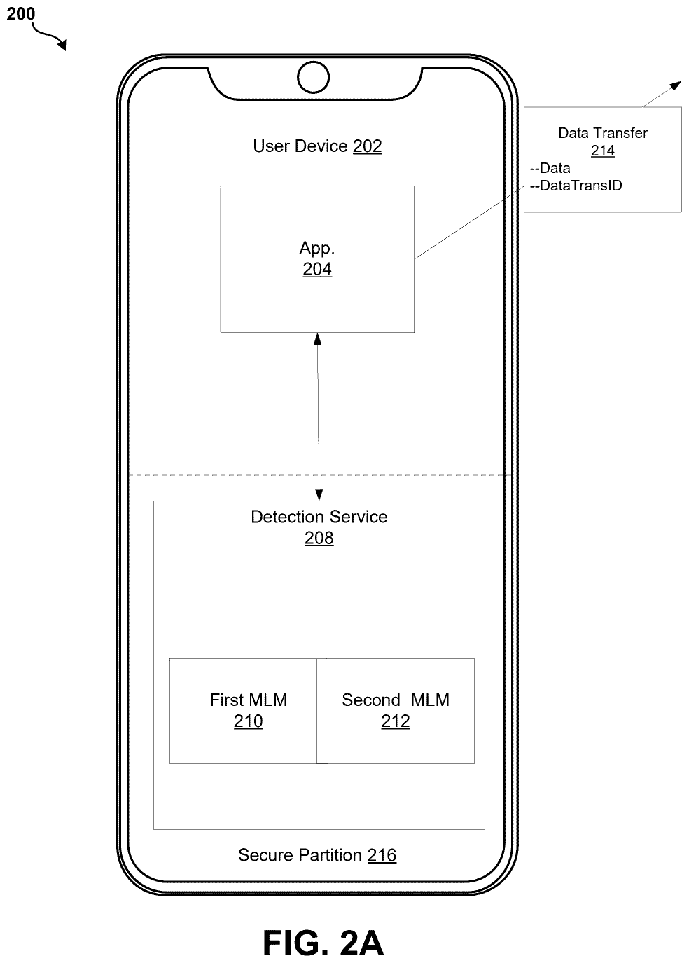

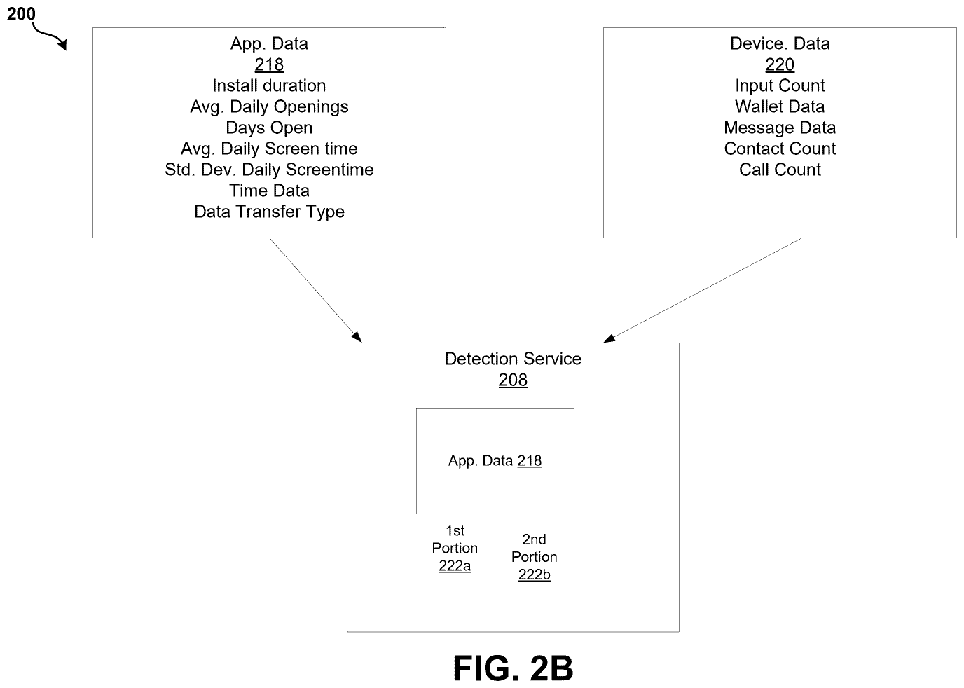

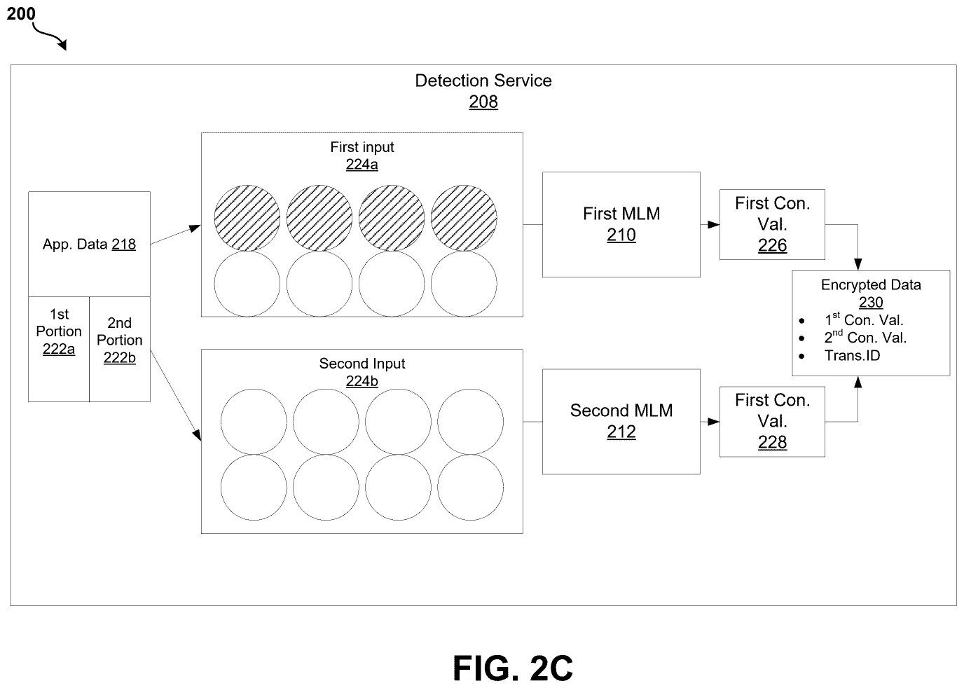

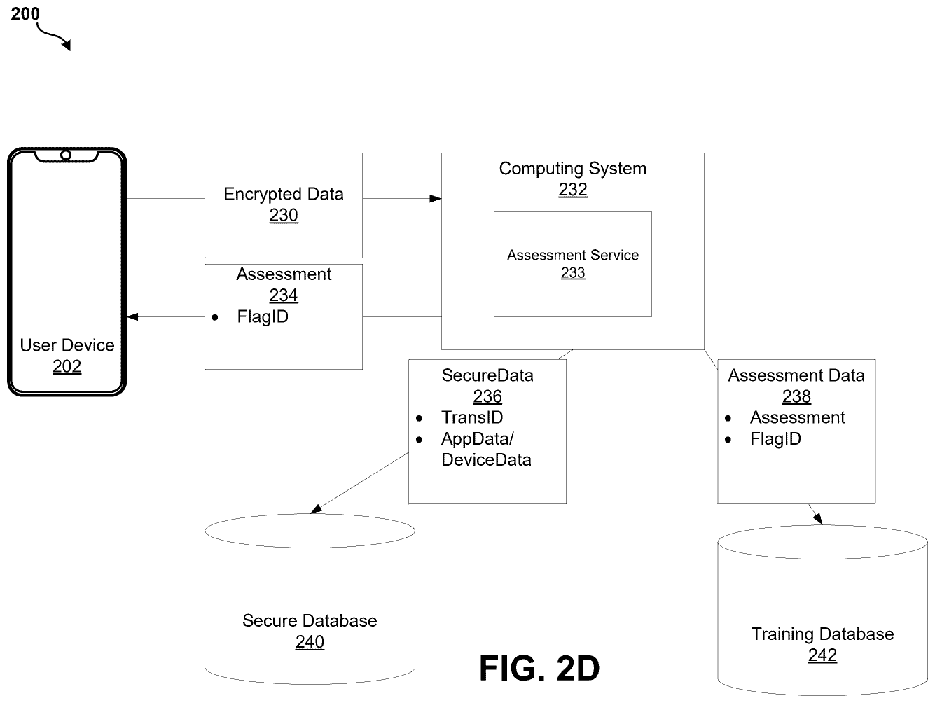

FIGS. 2A-2E illustrate a system 200 for detecting inauthentic data transfers, according to certain embodiments. As shown in FIG. 2A, the system 200 may include a user device 202, with an application 204, and a detection service 208. The detection service 208 may further include a first MLM 210 and a second MLM 212. The user device 202 may be similar to the user device 102 in FIG. 1 and include similar components and functionalities. Similarly, the detection service 208 may be similar to the detection service 106, and the first and second MLMs 210-212 may be similar to the first and second MLMs 116a-b. The detection service 208 may be included in a secure partition 216. The secure partition 216 may only be accessible to applications, APIs, etc. associated with and controlled by the entity. Put differently, anything in the secure partition 216—data, applications, etc. —may be hidden from and inaccessible to the user of the user device 202.

The application 204 may be used to initiate a data transfer 214. The data transfer 214 may be associated with an IAP, a request to download and install another application, and or any other type of data transfer. The data transfer 214 may include data to be transferred and an transfer ID. To perform the data transfer 214, some or all of the data needed to perform the data transfer 214 (e.g., IP addresses, identifiers for a purchase, credentials, payment information, etc.). Before or during the transmission of the data, the detection service 208 may determine that the data transfer 214 has been initiated. The detection service 208 may query one or more systems and subsystems of the user device 202 in order to detect that the data transfer 214 has been initiated. In some embodiments, the detection service 208 may be notified that the data transfer has been initiated (e.g., by the application 204, an operating system of the user device 202, and/or other suitable components).

FIG. 2B shows the detection service 208 accessing application data 218 and device data 220. The application data 218 and the device data 220 may be similar to the application signals 110 and the device signals 212, respectively. The application data 218 may be accessed by the detection service 208, or may be transmitted to the detection service 208 by some other component of the user device 202 (e.g., the operating system, another application, etc. The application data 218 may include application signals (or data points) related to the application 214. For example, the application data 218 may include install duration of the application 204 (i.e., how long the application has been installed on the mobile device), daily average application openings, application frequency (i.e., how often the application is opened within a given time period), average daily screen time, average session screen time, standard deviation of session screen time (i.e., how often the application 204 is open for during use), time data (e.g., when the application 204 was used, time windows, etc.), and other such information. The application signals 218 may also include information associated with other applications executed on the user device 202, such as an install duration of the earliest application, daily average openings of all applications, daily average screen time of some or all applications, number of applications opened for a time period (1 day, 1 week, etc.), time-usage data (e.g., time windows where applications are opened), and/or other such information.

The device data 220 may be determined from hardware and/or software components of the user device 202. The device data 220 may include data signals (or data points) associated with the user device 202 such as an input count (e.g., button usage), wallet data (e.g., stored payment methods, count of payment methods, usage data, etc.), email data (e.g., email application usage, email address(es), email address count, etc.), messaging data (e.g., SMS/MMS application usage, messaging frequency, etc.), contact data (e.g., most used contact(s), contact count, etc.), call data (e.g., count, frequency, etc.) and other such information. The device signals 220 may therefore potentially include sensitive information about the user and/or the mobile device 220. The device data 220 may therefore be accessed and/or determined by the detection service 208 within the secure environment 216 such that the user of the mobile device 202 may not access the device data 220.

The individual application signals and/or device signals may be selected based on mathematical modeling or another suitable technique. For example, a third MLM, associated with the entity and hosted on a computing system may use different set of device signal and/or application signals may to simulate the first and second MLMs 210-212. During the simulation, the third MLMs may assign different weights to each of the data points iteratively. Then, the results of each iteration may be analyzed for any risk to sensitive information. By simulating the various data points used as input for the first and second MLMs 210-212, the mathematical risk of a subtraction attack may be determined, and application signals and device signals chosen to minimize the risk of the subtraction attack.

The detection service 208 may then generate a first portion 222a and a second portion 222b of the device data 220. The first portion 222a and the second portion 222b may include identical device data (sometimes “device signals”) or may include separate device signals. In some embodiments, the data signals of the first and second portions 222a-b are predetermined and accessed from a lookup table or other storage component. Then, the first portion 222a and second portion 222b may then include the same respective data signals for each data transfer. The respective device signals in each of the first portion 222a and second portion 222b may then include differing sets of device signals from one another such that there is no overlap between the first and second portions 222a-b. In other embodiments, the first and second portions 222a-b may include at least some of the same device signals.

In another embodiment, the device signals may be divided into the first and second portions 222a-b randomly. Then, the first portion 222a may include different device signals for each data transfer. Similarly, the second portion 222b may include different device signals for each data transfer. If the first and second portions 222a-b are generated randomly, then there may be at least some overlap between the first and second portions 222a-b. Alternatively, the first and second portions 222a-b may be generated randomly with a condition restricting the first and second portions 222a-b to being unique to each other (i.e., no overlap). One of ordinary skill in the art would recognize many possibilities and configurations.

In FIG. 2C, the detection service 208 may utilize the application data 218 and the device data 220 (as the first and second portions 222a-b) as a first input 224a and a second input 224b for the first MLM 210 and the second MLM 212, respectively. The first input 224a may include the application data 218 and the first portion 222a. The second input 224b may include the second portion 222b. The data included in each of the respective first and second inputs 224a-b may include the same number of data points (e.g., device signals and/or application signals), as shown in FIG. 2C, or may include different numbers of data points.

The first and second MLMs 224a-b may each include a K-nearest neighbors model, a K-Means model, a hierarchical clustering model, logistic regression models, a Naive Bayes model, and/or any other suitable machine learning models. In some embodiments, the first and second MLMs 224a-b may include the same models. In other embodiments, the first and second MLMs 224a-b may include different models. The first and second MLMs 224a-b may be trained to output respective confidence values associated with the authenticity of data transfers based on respective inputs. The respective confidence values may be expressed as an integer (e.g., 1-10), a percentage (e.g., 10%, 90%, etc.), a float value (e.g., a decimal), or any other such value.

The first MLM 224a may determine a corresponding confidence value for each of the data points included in the first input 224a. For example, an application signal of the application data 218 may indicate that the install duration of the application 204 is 2 hours. The first MLM 224a may determine that 2 hours is relatively short and therefore likely to indicate that the data transfer 214, and in combination with other signals showing a similar adverse pattern, is an inauthentic (or fraudulent) data transfer. Accordingly, the first MLM 224a may generate a corresponding confidence value of 7 (e.g., out of 10). By contrast, if the install duration was longer (e.g., 10 months), the first MLM 224a may generate a corresponding confidence value indicating that the install duration does not make the data transfer 214 appear inauthentic (e.g., a corresponding confidence value of 1).

Similarly, the first MLM 224a may also generate confidence values for the device signals included in the first portion 222a. For example, the first portion 222a may include an input count associated with the data transfer 214 of 2. The first MLM 224a may determine that an input count of 2 is low for an average data transfer (e.g., indicating that an automated program may have initiated the data transfer 214) and, in combination with other signals showing a similar adverse pattern, indicates a possible inauthentic data transfer. The first MLM 224a may then assign a corresponding confidence value of 8. By contrast, the input count may be 30. The first MLM 224a may then assign the corresponding confidence value indicating that the data transfer 108 is likely not an inauthentic data transfer (e.g., a corresponding confidence value of 2). As above, the first MLM 224a may assign corresponding confidence values to some or all of the application data 218 and/or the first portion 222a. The corresponding confidence values may then collectively be output as the first confidence values 226.

The second MLM 224b may be identical to the first MLM 224a or may be different. The second MLM 224b may then generate corresponding confidence values for each of the device signals in the second portion 222b. For example, the second portion 222b may include a contact count indicating that there are 0 contacts stored on the user device 202. The second MLM 224b may then determine that a contact count of 0 is associated with inauthentic data transfers and assign a respective confidence value accordingly (e.g., 9). By contrast, a contact count of 300 may indicate and authentic data transfer, and the second MLM 224b may assign the corresponding confidence value accordingly (e.g., 1). The second MLM 224b may assign corresponding confidence values to each of the device signals of the second portion 222b, which may then be collectively output as the second confidence value 228.

Both the first and second MLMs 210-212 may weight each of the data points (e.g., application signals and/or device signals) included in their respective inputs equally, or may weight each data point separately. For example, the first input 224a may include an average daily openings of the application 204 (from the application data 218) and a call count of the user device 202 (from the device data 220). The first MLM 210 may determine that the average daily openings of an application is more predictive of an inauthentic data transfer than a call count. Thus, the data point corresponding to the average daily opening may be more heavily weighted than the call count. In some embodiments, the weights for each of the data points is static, pre-determined and coded within the first MLM 210. Additionally or alternatively, the weights for each data point may be adjusted either manually (e.g., re-coded) or as part of a learning/training process of the first MLM 210. Put differently, the weights for each of the data points may be dynamic, changing with each data transfer initiated on the user device 202, at regular intervals, or by any other suitable means and timeframe.

The first and second confidence values 226 and 228 may then be encrypted as encrypted data 230. The encrypted data 230 may also include the data transfer ID (identifying the data transfer 214), a device identifier associated with the user device 202, and other such information. The encrypted data 230 may include a single file with the first and second confidence values 230, or may include separate files as an encrypted data blob. The encrypted data 230 may be encrypted with the public key of a public private key pair. The public-private key pair may be administered by the entity associated with the user device 202. Thus, the public key may be stored within the secure partition 216 and be inaccessible to the user of the user device 202.

In FIG. 2D, the user device 202 may transmit the encrypted data 230 to a computing system 232. The computing system 232 may be associated with the entity. Therefore, the encrypted data 230 may be transmitted from the secure partition 216 to the computing system 232 within a secure environment managed by the entity, minimizing the risk of exposure of sensitive information. The computing system 232 may include one or more physical or virtual machines to perform one or more functions on the encrypted data 230. For example, the computing system 232 may include an assessment service 233. The assessment service 233 may decrypt some or all of the encrypted data 230 and analyze the corresponding confidence values using a third MLM (not shown), a rules based filter, or other such model to determine whether or not the data transfer 214 is authentic.

If the assessment service 233 determines, based at least in part on the application data 218 and/or the device data 220, that the data transfer 214 is inauthentic, the assessment service 233 may generate an assessment 234. The assessment 234 may include a flag ID indicating that the data transfer 214 is inauthentic. The assessment service 233 may then transmit the assessment 234 to the detection service 208 via the secure environment. The detection service 208 may then cause the data transfer 214 to be halted (e.g., generate a denial message, error message, etc.). Additionally or alternatively, the assessment service 233 and/or the detection service 208 may transmit some or all of the assessment 234 to another party involved in the data transfer 214, informing the other party that the data transfer 214 is inauthentic and/or denied.

The computing system 232 may then generate secure data 236. The secure data 236 may be encrypted (e.g., using the public-private key pair) and include the data transfer ID and the confidence scores corresponding to the application data 218 and/or the device data 220. The secure data 236 may then be stored on a secure database 240. The secure data 236 may then be accessed at a later point to generate training data for the first and/or second MLMs 210-212, and/or improve the functionality of the assessment service 233.

The computing system 232 may also generate assessment data 238. The assessment data 238 may include some or all of the assessment 234 generated from the encrypted data 230 by the assessment service 233 (or some other component of the computing system 232). The assessment data 238 may be stored on a training database 242. While the assessment data 238 may be derived from potentially sensitive information (e.g., the application data 218 and/or the device data 220), the assessment data 238 may not actually include any sensitive information. By contrast, the secure data 236 may include potentially sensitive data. By storing the assessment data 238 and the secure data 236 separately, the risk of exposing potentially sensitive information may be reduced or minimized.

The assessment data 238 and/or the secure data 236 may be subsequently used to retrain the first and second MLMs 210-212. For example, the data transfer 214 may be determined by the assessment module to be an inauthentic data transfer. However, it may be discovered later that the data transfer 214 was, in fact, authentic. The assessment data 238 and/or the secure data 236 may then be annotated and provided to the detection service 208. The detection service 208 may then cause the first and/or second MLMs 210-212 to be retrained. As a result of the retraining, the weight given to some or all of the data points within the application data 218 and/or the device data 220 may be adjusted in order to better identify inauthentic data transfers. Although FIGS. 2A-2D show the detection service 208 as being executed on the user device, in some embodiments, the detection service 208 may be executed on the computing system 323. Similarly, in some embodiments, the first and/or second MLM's 210-212 may be updated with different versions. The different versions may include MLM's retrained on the computing system 232. The retrained MLM's may then be pushed to the user device 202.

In some embodiments, the computing system 232 may include an analysis module. The analysis module may include one or more software and/or hardware components configured to analyze potential application signals and/or device signals. For example, the individual application signals and/or device signals may be selected by the analysis module based on mathematical modeling or another suitable technique. The analysis module may include a third MLM, associated with the entity and hosted on a computing system may use different set of device signal and/or application signals may to simulate the first and second MLMs 210-212. During the simulation, the third MLMs may assign different weights to each of the data points iteratively. Then, the results of each iteration may be analyzed for any risk to sensitive information. By simulating the various data points used as input for the first and second MLMs 210-212, the mathematical risk of a subtraction attack may be determined, and application signals and device signals chosen to minimize the risk of the subtraction attack.

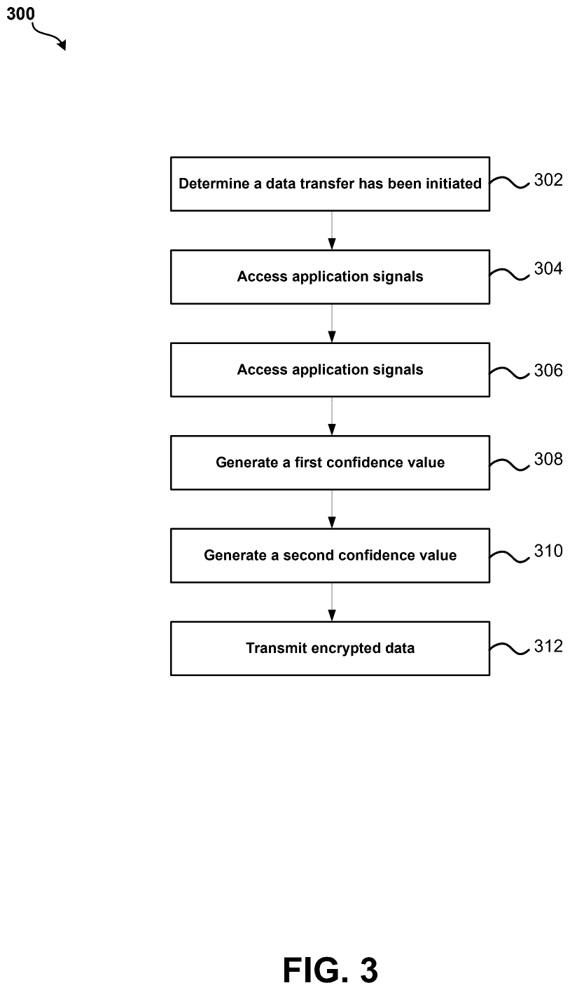

FIG. 3 illustrates a flowchart of a method 300 for identifying inauthentic data transfers, according to certain embodiments. The method 300 may be performed by some or all of the systems and devices herein, such as the system 200 in FIGS. 2A-2D. The steps of the method 300 may be performed in a different order than is presented here and/or may be combined with other steps. In some embodiments, some steps of the method 300 may be skipped altogether.

At 302, the method 300 may include determining, by a detection service executed on a user device, that a data transfer has been initiated within an application executed on the user device. The user device may be similar to the user device 102 in FIG. 1 and/or the user device 202 in FIG. 2. The detection service may be similar to the detection service 208 in FIG. 2 and be executed within a secure partition of the user device. The secure partition may be associated with an entity, such as a developer, manufacturer etc. of the user device. The entity may also be associated with one or more computing systems. The secure partition and the computing systems may be part of a secure environment, administered by the entity and inaccessible to the user of the user device. Within the secure environment the user device may transmit data to and from the computing systems of the entity such that the user of the user device may not access the data (e.g., sensitive information). Thus, the user device and the entity may communicate without sensitive data leaving the secure environment of the entity.

At 304, the method 300 may include accessing, by the detection service executed on the user device, one or more device signals indicating device use characteristics of the user device. The one or more device signals may be accessed from hardware and/or software components of the user device. The device signals may include data associated with the user device such as an input count (e.g., button usage), wallet data (e.g., stored payment methods, count of payment methods, usage data, etc.), email data (e.g., email application usage, email address(es), email address count, etc.), messaging data (e.g., SMS/MMS application usage, messaging frequency, etc.), contact data (e.g., most used contact(s), contact count, etc.), call data (e.g., count, frequency, etc.) and other such information. The device signals may potentially include sensitive information about the user and/or the user device. The device signals may therefore be accessed and/or determined within the secure environment such that the user of the user device may not access the device signals.

At 306, the method 300 may include accessing, by the application executed on the user device, one or more application signals associated with the application executed on the user device. The application signals may include data related to the application. For example, the application signals may include install duration of the application (i.e., how long the application has been installed on the mobile device), daily average application openings, application frequency (i.e., how often the application is opened within a given time period), average daily screen time, average session screen time, standard deviation of session screen time (i.e., how often the application is open for during use), time data (e.g., when the application was used, time windows, etc.), and other such information. The application signals may also include information associated with other applications executed on the user device, such as an install duration of the earliest application, daily average openings of all applications, daily average screen time of some or all applications, number of applications opened for a time period (1 day, 1 week, etc.), time-usage data (e.g., time windows where applications are opened), and/or other such information.

At 308, the method 300 may include generating, by a first machine learning model of the detection service, a first confidence value representing a likelihood that the data transfer is invalid based at least in part on the one or more application signals and a first portion of the one or more device signals. The first MLM may determine a corresponding confidence value for each of the data points included in the first input. For example, an application signal of the application data may indicate that the install duration of the application is 2 hours. The first MLM may determine that 2 hours is relatively short and therefore, in combination with other signals showing a similar adverse pattern, likely to indicate that the data transfer is an inauthentic (or fraudulent) data transfer. Accordingly, the first MLM may generate a corresponding confidence value of 7 (e.g., out of 10). By contrast, if the install duration was longer (e.g., 10 months), the first MLM may generate a corresponding confidence value indicating that the install duration does not make the data transfer appear inauthentic (e.g., a corresponding confidence value of 1).

Similarly, the first MLM may also generate confidence values for the device signals included in a first portion of the device signals. For example, the first portion may include an input count associated with the data transfer of 2. The first MLM may determine that an input count of 2 is low for an average data transfer (e.g., indicating that an automated program may have initiated the data transfer) and therefore, in combination with other signals showing a similar adverse pattern, indicates a possible inauthentic data transfer. The first MLM may then assign a corresponding confidence value of 8. By contrast, the input count may be 30. The first MLM may then assign the corresponding confidence value indicating that the data transfer is likely not an inauthentic data transfer (e.g., a corresponding confidence value of 2). As above, the first MLM may assign corresponding confidence values to some or all of the application data and/or the first portion. The corresponding confidence values may then collectively be output as the first confidence value.

At 310, the method 300 may include generating, by a second machine learning model of the detection service, a second confidence value representing the likelihood that the data transfer is invalid based at least in part on a second portion of the one or more device signals. For example, the second portion may include a contact count indicating that there are 0 contacts stored on the user device. The second MLM may then determine that a contact count of 0 is associated with inauthentic data transfers and assign a respective confidence value accordingly (e.g., 9). By contrast, a contact count of 300 may indicate and authentic data transfer, and the second MLM may assign the corresponding confidence value accordingly (e.g., 1). The second MLM may assign corresponding confidence values to each of the device signals of the second portion, which may then be collectively output as the second confidence value.

At 312, the method 300 transmitting, by the detection service, encrypted data comprising at least one of the first confidence value, and the second confidence value, or a data transfer identifier to a computing system. Some or all of the encrypted data may then be analyzed by an assessment service executed on the computing system. If the assessment service determines, based at least in part on the application signals and/or the device signals, that the data transfer is inauthentic, the assessment service may generate an assessment. The assessment may include a flag ID indicating that the data transfer is inauthentic and the data transfer ID. The assessment service may then transmit the assessment to the detection service via the secure environment. The detection service may then cause the data transfer to be halted (e.g., generate a denial message, error message, etc.). Additionally or alternatively, the assessment service and/or the detection service may transmit some or all of the assessment to another party involved in the data transfer, informing the other party that the data transfer is inauthentic and/or denied.

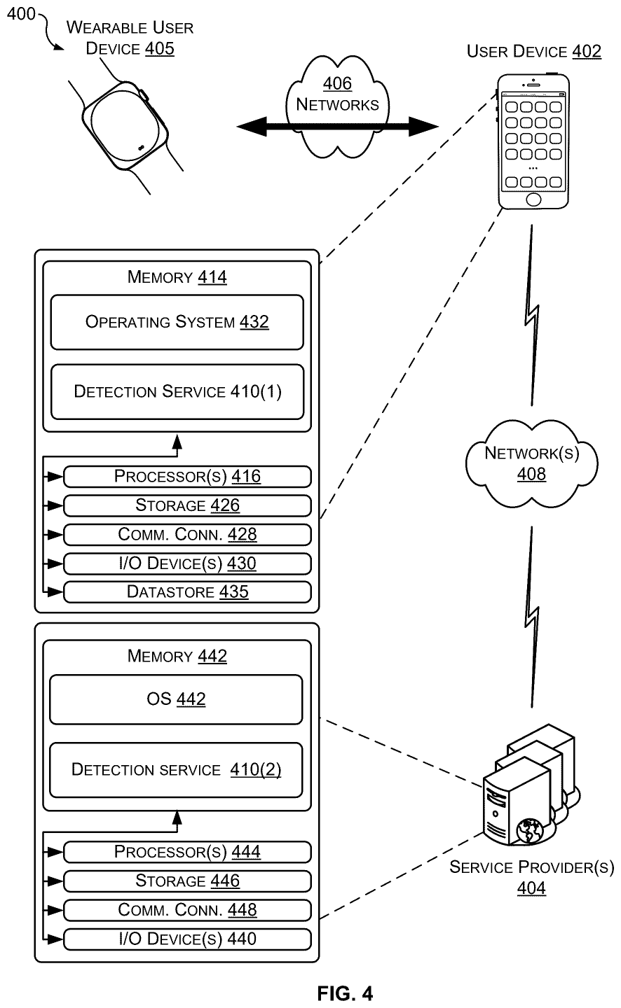

FIG. 4 illustrates an example architecture or environment 400 configured to implement techniques relating to providing route management, according to certain embodiments. In some examples, the example architecture 400 may further be configured to enable a user device 402 (e.g., the user device 102), the service provider computers 404 (e.g., the service provider 404), and a wearable electronic device 405 (e.g., an example accessory deice) to share information. In some examples, the devices may be connected via one or more networks 408 and/or 406 (e.g., via Bluetooth, WiFi, the Internet, or the like). In the architecture 400, one or more users may utilize the user device 402 to manage, control, or otherwise utilize the wearable electronic device 405, via the one or more networks 406. Additionally, in some examples, the wearable electronic device 405, the service provider computers 404, and the user device 402 may be configured or otherwise built as a single device. For example, the wearable electronic device 405 and/or the user device 402 may be configured to implement the examples described herein as a single computing unit, exercising the examples described above and below without the need for the other devices described.

In some examples, the networks 406, 408 may include any one or a combination of many different types of networks, such as cable networks, the Internet, wireless networks, cellular networks, satellite networks, other private and/or public networks, or any combination thereof. While the illustrated example represents the user device 402 accessing the service provider computers 404 via the networks 408, the described techniques may equally apply in instances where the user device 402 interacts with the service provider computers 404 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

The user device 402 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 402 may be in communication with the service provider computers 404 via the networks 408, 406, or via other network connections.

In one illustrative configuration, the user device 402 may include at least one memory 414 and one or more processing units (or processor(s)) 416. The processor(s) 416 may be implemented as appropriate in hardware, computer-executable instructions, firmware, or combinations thereof. Computer-executable instruction or firmware implementations of the processor(s) 416 may include computer-executable or machine-executable instructions written in any suitable programming language to perform the various functions described. The user device 402 may also include geo-location devices (e.g., a global positioning system (GPS) device or the like) for providing and/or recording geographic location information associated with the user device 402.

The memory 414 may store program instructions that are loadable and executable on the processor(s) 416, as well as data generated during the execution of these programs. Depending on the configuration and type of the user device 402, the memory 414 may be volatile (such as random access memory (RAM)) and/or non-volatile (such as read-only memory (ROM), flash memory, etc.). The user device 402 may also include additional removable storage and/or non-removable storage 426 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 414 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 414 and the additional storage 426, both removable and non-removable, are all examples of non-transitory computer-readable storage media. For example, non-transitory computer readable storage media may include volatile or non-volatile, removable or non-removable media implemented in any process or technology for storage of information such as computer-readable instructions, data structures, program modules, or other data. The memory 414 and the additional storage 426 are both examples of non-transitory computer storage media. Additional types of computer storage media that may be present in the user device 44 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 402. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 402 may also contain communications connection(s) 428 that allow the user device 402 to communicate with a data store, another computing device or server, user terminals, and/or other devices via the networks 408, 406. The user device 402 may also include I/O device(s) 430, such as a keyboard, a mouse, a pen, a voice input device, a touch input device, a display, an operating system 432 and/or one or more application programs or services for implementing the features disclosed herein including a detection service 410(1). In some examples, the detection service 410(1) may be configured to implement the features described herein such as those described with reference to the flowcharts. User device 402 may also include a Datastore 435. The Datastore 435 may be a separate memory partition within the memory 414 or may be an individual hardware component of the user device 402. The Datastore 435 may be configured as a sensitive data Datastore, and may not be accessible to a user of the user device 402.

The service provider computers 404 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 404 may be in communication with the user device 402 and/or the wearable user device 405 via the networks 408, 406, or via other network connections.

In one illustrative configuration, the service provider computers 404 may include at least one memory 442 and one or more processing units (or processor(s)) 444. The processor(s) 444 may be implemented as appropriate in hardware, computer-executable instructions, firmware, or combinations thereof. Computer-executable instruction or firmware implementations of the processor(s) 444 may include computer-executable or machine-executable instructions written in any suitable programming language to perform the various functions described.

The memory 442 may store program instructions that are loadable and executable on the processor(s) 444, as well as data generated during the execution of these programs. Depending on the configuration and type of service provider computer 404, the memory 442 may be volatile (such as RAM) and/or non-volatile (such as ROM, flash memory, etc.). The service provider computer 404 may also include additional removable storage and/or non-removable storage 446 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 442 may include multiple different types of memory, such as SRAM, DRAM, or ROM. While the volatile memory described herein may be referred to as RAM, any volatile memory that would not maintain data stored therein once unplugged from a host and/or power would be appropriate.

The memory 442 and the additional storage 446, both removable and non-removable, are both additional examples of non-transitory computer-readable storage media.

The service provider computer 404 may also contain communications connection(s) 448 that allow the service provider computer 404 to communicate with a data store, another computing device or server, user terminals and/or other devices via the networks 408, 406. The service provider computer 404 may also include I/O device(s) 440, such as a keyboard, a mouse, a pen, a voice input device, a touch input device, a display, speakers, a printer, etc. The memory 442 may include an operating system 442 and/or one or more application programs or services for implementing the features disclosed herein including the detection service 410(3). This version of the sensitive data application may be configured to perform similar operations as the detection service 410(1). Thus, in some examples, the detection service 410(3) may be configured to implement the features described herein such as those described with reference to the flowcharts.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from specific and legitimate sources to improve routing of stored routes by checking if they are navigable. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information. The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of customized routes, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app related to navigation or downloading routes that their personal information data may be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain financial applications, data de-identification can be used to protect a user's privacy and/or sensitive data. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method, comprising:
determining, by a detection service executed on a user device, that a data transfer has been initiated within an application executed on the user device;
accessing, by the detection service executed on the user device, one or more device signals indicating device use characteristics of the user device;
accessing, by the application executed on the user device, one or more application signals associated with the application executed on the user device;
generating, by a first machine learning model of the detection service, a first confidence value representing a likelihood that the data transfer is invalid based at least in part on the one or more application signals and a first portion of the one or more device signals;
generating, by a second machine learning model of the detection service, a second confidence value representing the likelihood that the data transfer is invalid based at least in part on a second portion of the one or more device signals; and
transmitting, by the detection service, encrypted data comprising at least one of the first confidence value, and the second confidence value, or a data transfer identifier to a computing system.

2. The method of claim 1, wherein the first portion of the one or more device signals and the second portion of the one or more device signals comprise different device signals.

3. The method of claim 1, wherein the first portion of the device signals and the second portion of the device signals each comprise an identical device signal.

4. The method of claim 1, wherein first machine learning model comprises at least one of a K-Nearest Neighbor model or a clustering model.

5. The method of claim 1, wherein an analysis module determines particular device signals and particular application signals to be used by the detection service.

6. The method of claim 1, further comprising:
determining, by the computing system, that the data transfer is a fraudulent data transfer based at least in part on the first confidence value, the second confidence value, or any combination thereof;
generating, by the computing system, a flag ID associated with the data transfer, the flag ID; and
transmitting, by the computing system, the flag ID to the user device and/or a third party.

7. The method of claim 1, wherein the one or more application signals comprise at least one of an install duration, a daily use metric, or an average run time.

8. A system, comprising:
one or more processors; and
a computer-readable medium comprising instructions that, when executed by the one or more processors, cause the system to:
determine, by a detection service executed on a user device, that a data transfer has been initiated within an application executed on the user device;
access, by the detection service executed on the user device, one or more device signals indicating device use characteristics of the user device;
access, by the application executed on the user device, one or more application signals associated with the application executed on the user device;
generate, by a first machine learning model of the detection service, a first confidence value representing a likelihood that the data transfer is invalid based at least in part on the one or more application signals and a first portion of the one or more device signals;
generate, by a second machine learning model of the detection service, a second confidence value representing the likelihood that the data transfer is invalid based at least in part on a second portion of the one or more device signals; and
transmit, by the detection service, encrypted data comprising at least one of the first confidence value, and the second confidence value, or a data transfer identifier to a computing system.

9. The system of claim 8, wherein the first portion of the one or more device signals and the second portion of one or more device signals comprise different device signals.

10. The system of claim 8, wherein the first portion of the one or more device signals and the second portion of the one or more device signals each comprise an identical device signal.

11. The system of claim 8, wherein first machine learning model comprises at least one of a K-Nearest Neighbor model or a clustering model.

12. The system of claim 8, wherein an analysis module determines particular device signals and particular application signals to be used by the detection service.

13. The system of claim 8, wherein the instructions further cause the system to:
determine, by the computing system, that the data transfer is an inauthentic data transfer based at least in part on the first confidence value, the second confidence value, or any combination thereof;
generate, by the computing system, a flag ID associated with the data transfer, the flag ID; and
transmit, by the computing system, the flag ID to the user device and/or a third party.

14. The system of claim 8, wherein the one or more application signals comprise at least one of an install duration, a daily use metric, or an average run time.

15. A non-transitory computer-readable medium comprising instructions that, when executed by one or more processors, cause the one or more processors to perform operations comprising:
determining, by a detection service executed on a user device, that a data transfer has been initiated within an application executed on the user device;
accessing, by the detection service executed on the user device, one or more device signals indicating device use characteristics of the user device;
accessing, by the application executed on the user device, one or more application signals associated with the application executed on the user device;
generating, by a first machine learning model of the detection service, a first confidence value representing a likelihood that the data transfer is invalid based at least in part on the one or more application signals and a first portion of the one or more device signals;
generating, by a second machine learning model of the detection service, a second confidence value representing the likelihood that the data transfer is invalid based at least in part on a second portion of the one or more device signals; and
transmitting, by the detection service, encrypted data comprising at least one of the first confidence value, and the second confidence value, or a data transfer identifier to a computing system.

16. The non-transitory computer-readable medium of claim 15, wherein the first portion of the one or more device signals and the one or more second portion of device signals comprise different device signals.

17. The non-transitory computer-readable medium of claim 15, wherein the first portion of the one or more device signals and the second portion of the one or more device signals each comprise an identical device signal.

18. The non-transitory computer-readable medium of claim 15, wherein first machine learning model comprises at least one of a K-Nearest Neighbor model or a clustering model.

19. The non-transitory computer-readable medium of claim 15, wherein an analysis module determines particular device signals and particular application signals to be used by the detection service.

20. The non-transitory computer-readable medium of claim 15, further comprising:
determining, by the computing system, that the data transfer is an inauthentic data transfer based at least in part on the first confidence value, the second confidence value, or any combination thereof;
generating, by the computing system, a flag ID associated with the data transfer, the flag ID; and
transmitting, by the computing system, the flag ID to the user device and/or a third party.
